(19) United States
(12) Patent Application Publication
(10) Pub. No.: US 2010/0057654 A1
(43) Pub. Date: Mar. 4, 2010

(54) SELF-LEARNING SYSTEM AND METHOD FOR PROVIDING A LOTTERY TICKET AT A POINT OF SALE DEVICE

(75) Inventors: Jonathan OTTO, Palm Beach, FL (US); Andrew VAN LUCHENE, Santa Fe, NM (US)

Correspondence Address: SIMPSON & SIMPSON, PLLC, 5555 MAIN STREET, WILLIAMSVILLE, NY, 14221-5406, US

(73) Assignee: RETAILDNA, LLC, Lake Worth, FL (US)

(21) Appl. No.: 12/618,267

(22) Filed: Nov. 13, 2009

Related U.S. Application Data
(63) Continuation-in-part of application No. 12/151,042, filed on May 2, 2008.
Application No. 12/151,042 is a continuation-in-part of application No. 12/151,038, filed on May 2, 2008.
Application No. 12/151,038 is a continuation-in-part of application No. 12/151,043, filed on May 2, 2008.
Application No. 12/151,042 is a continuation-in-part of application No. 11/983,679, filed on Nov. 9, 2007.
Application No. 11/983,679 is a continuation-in-part of application No. 09/993,228, filed on Nov. 14, 2001.
Application No. 12/151,038 is a continuation-in-part of application No. 11/983,679, filed on Nov. 9, 2007.
Application No. 11/983,679 is a continuation-in-part of application No. 09/993,228, filed on Nov. 14, 2001.
Application No. 12/151,043 is a continuation-in-part of application No. 11/983,679, filed on Nov. 9, 2007.
Application No. 11/983,679 is a continuation-in-part of application No. 09/993,228, filed on Nov. 14, 2001.

(51) Int. Cl. G06N 3/08; G06N 5/02; G06Q 20/00; G06Q 30/00

(52) U.S. Cl. 706/25; 706/47; 705/21; 705/14.65

(57) ABSTRACT

A system for managing a purchase agreement, including: a memory element for at least one specially-programmed general purpose computer, for storing an artificial intelligence program (AIP), and a purchase agreement between a customer and at least one business entity, the purchase agreement including at least one requirement regarding at least one retail transaction between the customer and the at least one business entity; a processor in the computer for: compiling a purchasing history for the customer with respect to the at least one business entity and the purchase agreement, the memory element for storing the purchasing history and modifying, using the processor, the purchasing history, and the AIP, the at least one requirement to increase revenue or profitability of the at least one business entity; and an interface element in the computer for transmitting the modified at least one requirement for presentation to the customer.

### CROSS-REFERENCE TO RELATED APPLICATIONS

This is a continuation-in-part patent application under 35 USC 120 of U.S. patent application Ser. No. 12/151,042, filed May 2, 2008 and entitled “METHOD AND SYSTEM FOR GENERATING AN OFFER AND TRANSMITTING THE OFFER TO A WIRELESS COMMUNICATIONS DEVICE,” of U.S. patent application Ser. No. 12/151,038, filed May 2, 2008 and entitled “METHOD AND APPARATUS FOR GENERATING AND TRANSMITTING AN ORDER INITIATION OFFER TO A WIRELESS COMMUNICATIONS DEVICE,” and of U.S. patent application Ser. No. 12/151,043, filed May 2, 2008 and entitled “METHOD AND SYSTEM FOR CENTRALIZED GENERATION OF A BUSINESS EXECUTABLE USING GENETIC ALGORITHMS AND RULES DISTRIBUTED AMONG MULTIPLE HARDWARE DEVICES,” each of which is a continuation-in-part of U.S. patent application Ser. No. 11/983,679, filed Nov. 9, 2007 and entitled “Method and System for Generating, Selecting, and Running Executables in a Business System Utilizing a Combination of User Defined Rules and Artificial Intelligence” which is a continuation-in-part patent application under 35 USC 120 of U.S. patent application Ser. No. 09/993,228, filed Nov. 14, 2001 and entitled “Method and apparatus for dynamic rule and/or offer generation,” which applications are incorporated herein by reference.

This application is related to: U.S. patent application Ser. No. 09/052,093 entitled “Vending Machine Evaluation Network” and filed Mar. 31, 1998; U.S. patent application Ser. No. 09/083,483 entitled “Method and Apparatus for Selling an Aging Food Product” and filed May 22, 1998; U.S. patent application Ser. No. 09/282,747 entitled “Method and Apparatus for Providing Cross-Benefits Based on a Customer Activity” and filed Mar. 31, 1999; U.S. patent application Ser. No. 08/943,483 entitled “System and Method for Facilitating Acceptance of Conditional Purchase Offers (CPOs)” and filed on Oct. 3, 1997, which is a continuation-in-part of U.S. patent application Ser. No. 08/923,683 entitled “Conditional Purchase Offer (CPO) Management System For Packages” and filed Sep. 4, 1997, which is a continuation-in-part of U.S. patent application Ser. No. 08/889,319 entitled “Conditional Purchase Offer Management System” and filed Jul. 8, 1997, which is a continuation-in-part of U.S. patent application Ser. No. 08/707,660 entitled “Method and Apparatus for a Cryptographically Assisted Commercial Network System Designed to Facilitate Buyer-Driven Conditional Purchase Offers,” filed on Sep. 4, 1996 and issued as U.S. Pat. No. 5,794,207 on Aug. 11, 1998; U.S. patent application Ser. No. 08/920,116 entitled “Method and System for Processing Supplementary Product Sales at a Point-Of-Sale Terminal” and filed Aug. 26, 1997, which is a continuation-in-part of U.S. patent application Ser. No. 08/822,709 entitled “System and Method for Performing Lottery Ticket Transactions Utilizing Point-Of-Sale Terminals” and filed Mar. 21, 1997; U.S. patent application Ser. No. 09/135,179 entitled “Method and Apparatus for Determining Whether a Verbal Message Was Spoken During a Transaction at a Point-Of-Sale Terminal” and filed Aug. 17, 1998; U.S. patent application Ser. No. 09/538,751 entitled “Dynamic Propagation of Promotional Information in a Network of Point-of-Sale Terminals” and filed Mar. 30, 2000; U.S. patent application Ser. No. 09/442,754 entitled “Method and System for Processing Supplementary Product Sales at a Point-of-Sale Terminal” and filed Nov. 12, 1999; U.S. patent application Ser. No. 09/045,386 entitled “Method and Apparatus For Controlling the Performance of a Supplementary Process at a Point-of-Sale Terminal” and filed Mar. 20, 1998; U.S. patent application Ser. No. 09/045,347 entitled “Method and Apparatus for Providing a Supplementary Product Sale at a Point-of-Sale Terminal” and filed Mar. 20, 1998; U.S. patent application Ser. No. 09/083,689 entitled “Method and System for Selling Supplementary Products at a Point-of Sale and filed May 21, 1998; U.S. patent application Ser. No. 09/045,518 entitled “Method and Apparatus for Processing a Supplementary Product Sale at a Point-of-Sale Terminal” and filed Mar. 20, 1998; U.S. patent application Ser. No. 09/076,409 entitled “Method and Apparatus for Generating a Coupon” and filed May 12, 1998; U.S. patent application Ser. No. 09/045,084 entitled “Method and Apparatus for Controlling Offers that are Provided at a Point-of-Sale Terminal” and filed Mar. 20, 1998; U.S. patent application Ser. No. 09/098,240 entitled “System and Method for Applying and Tracking a Conditional Value Coupon for a Retail Establishment” and filed Jun. 16, 1998; U.S. patent application Ser. No. 09/157,837 entitled “Method and Apparatus for Selling an Aging Food Product as a Substitute for an Ordered Product” and filed Sep. 21, 1998, which is a continuation of U.S. patent application Ser. No. 09/083,483 entitled “Method and Apparatus for Selling an Aging Food Product” and filed May 22, 1998; U.S. patent application Ser. No. 09/603,677 entitled “Method and Apparatus for selecting a Supplemental Product to offer for Sale During a Transaction” and filed Jun. 26, 2000; U.S. Pat. No. 6,119,100 entitled “Method and Apparatus for Managing the Sale of Aging Products and filed Oct. 6, 1997 and U.S. Provisional Patent Application Ser. No. 60/239,610 entitled “Methods and Apparatus for Performing Upsells” and filed Oct. 11, 2000.

By “related to” we mean that the present application and the applications noted above are in the same general technological area and have a common inventor or assignee. However, “related to” does not necessarily mean that the present application and any or all of the applications noted above are patentably indistinct, or that the filing date for the present application is within two months of any of the respective filing dates for the applications noted above.

### BACKGROUND OF THE INVENTION

The invention relates generally to a method and system for presenting an offer for a lottery ticket in lieu of change due for a transaction and, more particularly, to a self-learning method and system for providing such offer using artificial intelligence.

The management of purchasing agreements is known, for example, as disclosed in U.S. Published Patent Applications 2007/0250388 (Walker et al.), incorporated by reference herein.

### SUMMARY OF THE INVENTION

The invention broadly comprises a system for managing a purchase agreement, including: a memory element for at least one specially-programmed general purpose computer, for storing an artificial intelligence program (AIP), and a first purchase agreement between a customer and at least one business entity, the first purchase agreement including at least one first requirement regarding at least one first retail transaction between the customer and the at least one business entity; a processor in the at least one specially-programmed general purpose computer for: compiling a first purchasing history for the customer with respect to the at least one business entity and the first purchase agreement, the memory element for storing the first purchasing history and modifying, using the processor, the first purchasing history, and the AIP, the at least one first requirement to increase revenue or profitability of the at least one business entity; and an interface element in the at least one specially-programmed general purpose computer for transmitting the modified at least one first requirement for presentation to the customer.

In one embodiment, the processor is for: modifying the at least one first requirement using an operational or financial parameter regarding the at least one business entity; or generating, using the processor and the AIP, the first purchase agreement to optimize revenue or profitability of the at least one business entity. In another embodiment, the processor is for generating the first purchase agreement using an operational or financial parameter regarding the at least one business entity, or using a second purchasing history for the first customer.

In one embodiment, the memory element is for storing a second purchase agreement between the customer and the at least one business entity, the second purchase agreement including at least one second requirement regarding at least one second retail transaction between the customer and the at least one business entity; and the processor is for: compiling a second purchasing history for the customer with respect to the at least one business entity and the at least one second purchase agreement, the memory element for storing the respective second purchasing history in the memory element; determining, using the first and second purchasing histories, a relative profitability of the first and second purchasing agreements; and modifying, using the relative profitability and the AIP, the first or second requirement to increase revenue or profitability of the at least one business entity.

In one embodiment, the interface element is for receiving an offer from the customer to enter into a third purchase agreement with the at least one business entity, the third purchase agreement including at least one third requirement regarding at least one third retail transaction between the customer and the at least one business entity, and the processor is for: determining a profitability of the third purchase agreement; and for a profitability less than a specified value, modifying, using the processor and the AIP, the at least one third requirement to increase revenue or profitability of the at least one business entity. The interface element is for transmitting the modified at least one third requirement.

In one embodiment, the processor is for determining, using the AIP, an incentive with respect to compliance with the first purchase agreement and the interface element is for transmitting the incentive with the modified at least one first requirement.

The invention also broadly comprises a system for managing a purchase agreement, including: a memory element for at least one specially-programmed general purpose computer for storing an artificial intelligence program (AIP); a processor for the at least one specially-programmed general purpose computer for: generating, using the AIP, a first purchase agreement between a customer and at least one business entity, the first purchase agreement to optimize revenue or profitability of the at least one business entity and including at least one first requirement regarding at least one first retail transaction between the customer and the at least one business entity; compiling a first purchasing history for the customer with respect to the at least one business entity and the first purchase agreement, the memory element for storing the first purchasing history; and modifying, using the first purchasing history and the AIP, the at least one first requirement to increase revenue or profitability of the at least one business entity; and an interface element in the at least one specially-programmed general purpose computer for transmitting, the modified at least one first requirement for presentation to the customer.

The invention further broadly comprises a system for managing a purchase agreement, including: an interface element for at least one specially-programmed general purpose computer for receiving an offer from a customer to enter into a purchase agreement with at least one business entity, the first purchase agreement including at least one first requirement regarding at least one first retail transaction between the customer and the at least one business entity; a memory element for the at least one specially-programmed general purpose computer for storing an artificial intelligence program (AIP); and a processor for the at least one specially-programmed general purpose computer for: determining a profitability of the first purchase agreement; and for a profitability less than a specified value, modifying, using the AIP, the at least one first requirement to increase revenue or profitability of the at least one business entity. The interface element is for transmitting the modified at least one first requirement for presentation to the customer.

The invention still further broadly comprises a method for managing a purchase agreement.

It is a general object of the present invention to provide a system and a method to manage a purchasing agreement that is dynamic and can be readily adapted to meet various and variable requirements.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing FIGURES, in which:

FIG. 1 is a schematic block diagram of a present invention system for managing a purchase agreement.

### DETAILED DESCRIPTION OF THE PREFERRED EMBODIMENT

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein shall include the same meaning as commonly understood to one of ordinary skill in the art to which this invention belongs. Although any methods, devices or materials similar or equivalent to those described herein can be used in the practice or testing of the invention, the preferred methods, devices, and materials are now described.

It should be understood that the use of “or” in the present application is with respect to a “non-exclusive” arrangement, unless stated otherwise. For example, when saying that “item x is A or B,” it is understood that this can mean one of the following: 1) item x is only one or the other of A and B; and 2) item x is both A and B. Alternately stated, the word “or” is not used to define an “exclusive or” arrangement. For example, an “exclusive or” arrangement for the statement “item x is A or B” would require that x can be only one of A and B.

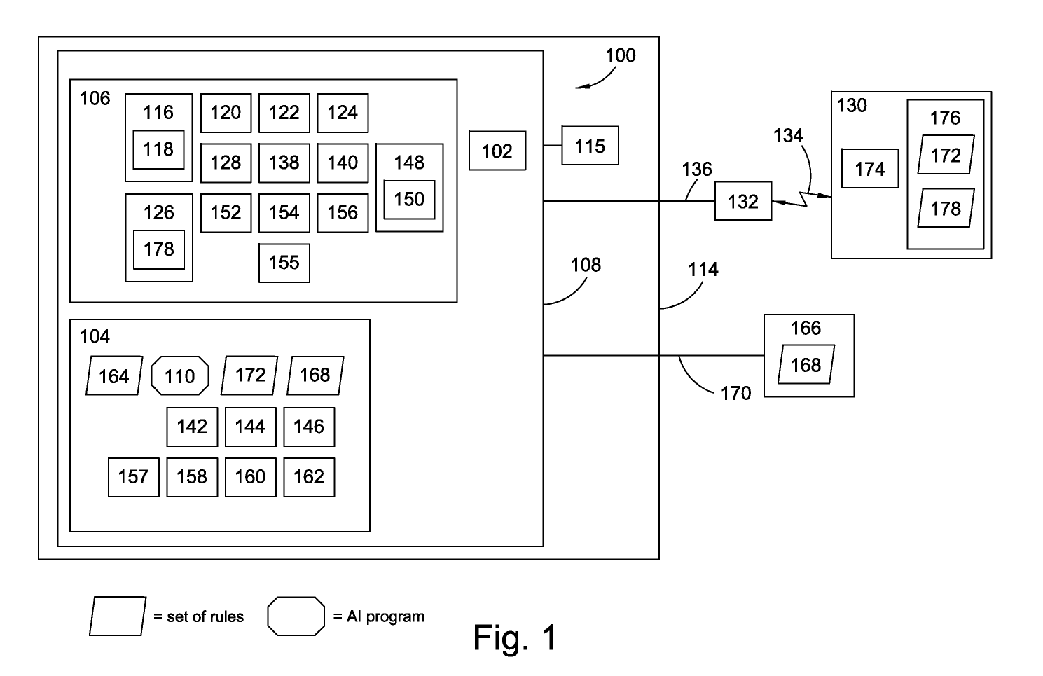

FIG. 1 is a schematic block diagram of present invention system 100 for providing a lottery ticket at a point of sale device. The system includes interface element 102, memory element 104, and processor 106 for at least one specially programmed computer, for example, computer 108. The memory element is for storing artificial intelligence program (AIP) 110. The interface element is for communicating with a point of sales (POS) device to implement a retail transaction (not shown) with a business entity, for example, a business entity associated with location 114. The POS device can be any POS device known in the art. In one embodiment, the POS device is self-serve kiosk 115 located at a location associated with the first business entity, such as location 114. In another embodiment (not shown), the POS device is remote from a location associated with business entity, such as location 114, for example, the POS device is a self-serve kiosk in a common area, such as a lobby.

By interface element, we mean any combination of hardware, firmware, or software in a computer used to enable communication or data transfer between the computer and a device, system, or network external to the computer. The interface element can connect with the device, system, or network external to the computer using any means known in the art, including, but not limited to a hardwire connection, an optical connection, an Internet connection, or a radio frequency connection. Processor 106 and interface element 102 can be any processor or interface element, respectively, or combination thereof, known in the art.

Computer 108 can be any computer or plurality of computers known in the art. In one embodiment, the computer is located in a retail location with which system 100 is associated, for example, location 114. In another embodiment (not shown), all or parts of the computer are remote from retail locations with which system 100 is associated. In a further embodiment, computer 108 is associated with a plurality of retail locations with which system 100 is associated. Thus, the computer provides the functionality described for more than one retail location.

The processor is for determining whether amount 116 due for goods or services included in the retail transaction includes coin 118 amount with a value less than one dollar. For example, an amount due of $4.75 includes a coin amount of $0.75, or 75 cents; and an amount due of $0.49 includes a coin amount of 49 cents. As another example, an amount due equal to a whole number of dollars, for example, $45.00, does not have a coin amount. If the amount due includes a coin amount, system 100 continues a process for providing a lottery ticket. If the amount due does not include a coin amount, system 100 does not continue a process for providing a lottery ticket. The lottery can be any lottery known in the art that is in compliance with legal requirements applicable to the lottery.

For a retail transaction with a coin amount, the processor is for identifying an item or service included in the retail transaction, that is determining identification 120 for an item or service included in the retail transaction, and determining identification 122 of a customer (not shown) for the retail transaction. That is, the customer is engaged in the transaction using the POS device. The processor also identifies a payment method used for the retail transaction, for example, the processor determines identification 124 of the payment method. Any payment method known in the art can be used and identified, including, but not limited to: credit card, debit card, cash, check, coupon, credit voucher, or reward certificate.

The present invention uses available data regarding a retail transaction to dynamically apply intelligence to making a determination regarding presentation of a lottery ticket for a lottery from at least one lottery. By “a lottery from at least one lottery” we mean that in one case there is only one lottery and the lottery ticket is for that one lottery, and in another case, there is a plurality of lotteries and the lottery ticket is for one lottery from the plurality of lotteries. The following describes the non-limiting example, in which there is only one lottery. The processor determines, using the AIP and identifications 120, 122, and 124 whether to present offer 126 to provide a lottery ticket (not shown). For a determination to present the offer, that is, in the case when the processor determines that an offer is to be presented, the processor determines change amount 128 equal to a difference between one dollar and the coin amount and generates the offer using the AIP. The interface element is for transmitting the offer for presentation by the POS device.

For example, in the case in which the amount due is $4.75 and the coin amount is $0.75, or 75 cents, the change amount is $0.25 or 25 cents. The offer includes the provision of the lottery ticket in lieu of providing the change amount to the customer. For example, at the conclusion of a transaction, the customer is presented with an amount due, for example, $4.75. As applicable, the customer is informed of an amount of change, for example, change amount 128, in less than a whole dollar amount, associated with the amount due. The customer is then presented with an offer to receive a lottery ticket instead of the change amount.

In one embodiment, the POS device is a wireless communications device (WCD), for example, WCD 130. WCD 130 can be any WCD known in the art. Commonly-owned and co-pending U.S. patent application Ser. No. 12/151,040, entitled “METHOD AND SYSTEM FOR MANAGING TRANSACTIONS INITIATED VIA A WIRELESS COMMUNICATIONS DEVICE”, filed May 2, 2008 is applicable to interaction of the WCD and system 100.

In one embodiment, a WCD usable with system 100, for example, WCD 130, is owned by, leased by, or otherwise already in possession of an end user when system 100 interfaces with the WCD. In the description that follows, it is assumed that the WCD is owned by, leased by, or otherwise already in possession of the end user when system 100 interfaces with the WCD. In general, the WCD communicates with a network, for example, network 132, via radio-frequency connection 134. Network 132 can be any network known in the art. In one embodiment, the network is located outside of the retail location, for example, the network is a commercial cellular telephone network. In one embodiment (not shown), the network is located in a retail location, for example, the network is a local network, such as a Bluetooth network. The interface element can connect with network 132 using any means known in the art, including, but not limited to a hardwire connection, an optical connection, an Internet connection, or a radio frequency connection. In the figures, a non-limiting example of a hardwire connection 136 is shown. In one embodiment, device 130 is connectable to a docking station (not shown) to further enable communication between device 130 and system 100. Any docking station or docking means known in the art can be used. That is, when the device is connected to the docking station, a link is established between the device and system 100.

In one embodiment, the processor is for evaluating, with respect to parameter 138 and using the AIP, identifications 120, 122, or 124, for example, the process generates evaluation 140 regarding parameter 138 and identifications 120, 122, or 124. In one embodiment, parameter 138 is stored in element 104. In one embodiment less than all identifications 120, 122, and 124 are used in the evaluation. In another embodiment, each of identifications 120, 122, and 124 are used in the evaluation. The processor determines whether to present the offer using the AIP and evaluation 140, or using the AIP and evaluation 140 in conjunction with some or all of identifications 120, 122, and 124. In one embodiment, the processor makes a positive determination to present an offer only for specified payment methods for the retail transaction. For example, the processor only makes a determination to present an offer when a credit card is used for the retail transaction. Alternately stated, when the payment method is other than a credit card, the processor is for determining not to provide an offer.

In one embodiment, the processor is for accessing payment method transaction history 142 regarding at least one transaction (not shown) previously enacted with the business entity using the payment method identified by identification 122. The processor determines whether to present the offer using the AIP and history 142 or using the AIP and history 142 in conjunction with some or all of identifications 120, 122, and 124. In one embodiment, history 142 is stored in memory element 104. In another embodiment (not shown), history 142 is stored in a computer other than computer 102. In one embodiment, the processor compiles or updates history 142.

In one embodiment, the processor is for accessing customer transaction history 144 regarding at least one transaction (not shown) previously enacted between the customer and the business entity. The processor determines whether to present the offer using the AIP and history 144, or using the AIP and history 144 in conjunction with some or all of identifications 120, 122, and 124. In one embodiment, history 144 is stored in memory element 104. In another embodiment (not shown), history 144 is stored in a computer other than computer 102. In one embodiment, the processor compiles history 144.

In one embodiment, the processor is for accessing retail transaction history 146 regarding at least one transaction (not shown) previously enacted with the business entity and including the item or service identified in identification 124. The processor determines whether to present the offer using the AIP and history 146, or using the AIP and history 146 in conjunction with some or all of identifications 120, 122, and 124. In one embodiment, history 146 is stored in memory element 104. In another embodiment (not shown), history 146 is stored in a computer other than computer 102. In one embodiment, the processor compiles history 146.

In one embodiment, the processor is for accessing one or more of histories 142, 144, or 146 and determining whether to present the offer using the AIP and one or more of histories 142, 144, or 146, or using the AIP and one or more of histories 142, 144, or 146 in conjunction with some or all of identifications 120, 122, and 124.

In one embodiment, system 100 self-learns based upon historical data regarding previous retails transactions, operations, and previous offers. The interface element communicates with at least one POS device, for example, device 115, to implement a plurality of retail transactions (not shown) with the business entity. The interface element can interact with device 115 or can interact with other POS devices. Thus, system 100 can be involved with a plurality of retail transactions.

The processor is for determining whether respective amount due 148 for respective goods or services (not shown) included in each retail transaction included in the plurality of retail transactions includes respective coin amount 150 with a value less than one dollar. If the amount due includes a coin amount, system 100 continues a process for providing a lottery ticket. If the amount due does not include a coin amount, system 100 does not continue a process for providing a lottery ticket.

Thus, for each retail transaction, from the plurality of retail transactions, with a coin amount, the processor identifies a respective item or service (not shown) included in the retail transactions, for example, the processor determines identification 152 identifying such respective items or services. The item or service can be different for various of the transactions or can be the same for all of the transactions. The processor determines an identification of a respective customer involved in each retail transaction, for example, the processor determines identification 154 identifying the respective customers. That is, each customer involved in a transaction from the plurality of transaction is identified. The processor also is for identifying a respective payment method for each retail transaction, for example, determining identification 156 identifying the respective payment methods.

The present invention uses available data regarding retail transactions to dynamically apply intelligence to making a determination regarding presentations of lottery tickets. In one embodiment, the processor is for evaluating, with respect to parameter 155 and using the AIP, identifications 152, 154, and 156, for example, the process generates evaluation 157 regarding parameter 155 and identifications 152, 154, and 156. In one embodiment, parameter 155 is stored in element 104. In one embodiment less than all identifications 152, 154, and 156 are used in the evaluation. In another embodiment, each of identifications 152, 154, and 156 are used in the evaluation. The processor determines whether to present the offer using the AIP and evaluation 157, or using the AIP and evaluation 157 in conjunction with some or all of identifications 152, 154, and 156. For each determination to present a respective offer, that is, for the retail transactions in which the processor determines that a respective offer is to be presented, the processor determines a respective change amount, for example, change amount 128, equal to a difference between one dollar and the respective coin amount and generates the respective offer using the AIP. The interface element is for transmitting the respective offer for presentation by the at least one POS device.

The processor also compiles or updates offer transaction history 158 including information related to acceptance and refusal of the respective offers. For example, history 158 includes information identifying respective offers that were accepted and respective offers that were accepted. In one embodiment, the processor stores history 158 in element 104. In addition, the processor can compile any other information known in the art and available regarding the presented offers. In one embodiment and for a retail transaction executed following compilation of history 158, the processor uses the AIP and history 158 to determine whether to present an offer, for example, offer 126, to provide a lottery ticket; or to generate an offer, for example, offer 126. In another embodiment and for a retail transaction executed following compilation of history 158, the processor determines whether to present an offer; or to generate an offer, for example, offer 126, using the AIP and history 158 in conjunction with some or all of identifications 152, 154, and 156. The discussion supra regarding histories 142, 144, and 146 also is applicable to the plurality of retail transactions and to a retail transaction occurring subsequent to compilation of history 158.

In one embodiment, the at least one lottery includes a plurality of lotteries (not shown) and the processor is for selecting, using the AIP, a respective lottery from the plurality of lotteries and generating offer 126 to include the provision of a lottery ticket for the respective lottery. In one embodiment, the processor compiles or updates offer transaction history 160 for previously presented offers including at least one offer with a lottery selected from a plurality of lotteries. In one embodiment, the processor stores history 160 in element 104. History 160 includes information related to acceptance and refusal of the offers. For example, history 160 includes information identifying offers that were accepted and offers that were accepted. In addition, the processor can compile any other information known in the art and available regarding the presented offers. In one embodiment, the processor selects the respective lottery using the AIP and history 160. In another embodiment, the processor selects the respective lottery using the AIP and history 160 in conjunction with some or all of identifications 152, 154, and 156. The discussion supra regarding histories 142, 144, and 146 also is applicable to the plurality of retail transactions and to a retail transaction occurring subsequent to compilation of history 160.

In one embodiment, the processor is for accessing one or more of histories 158 or 160 and determining whether to present the offer using the AIP and one or more of histories 158 or 160, or using the AIP and one or more of histories 158 or 160 in conjunction with some or all of identifications 152, 154, and 156.

It should be understood that identifications 120, 122, 124, 152, 154, or 156 and histories 142, 144, and 146 also can be used by the processor, in some embodiments, with the AIP as well, to select the respective lottery from the plurality of lotteries. It also should be understood that history 158, and in some aspects, the AIP as well, can be used to determine whether to present an offer, for example, offer 126, to provide a lottery ticket; or to generate an offer, for example, offer 126.

In one embodiment, the processor determines, using the AIP, whether to present an offer to provide a lottery ticket based on the value of coin amount 150. For example, if the value is not equal to a minimum amount, the offer is not provided. Any of the identifications or histories discussed supra can be used by the processor along with the value of coin amount 150 to determine whether to present an offer to provide a lottery ticket. In addition, parameter 162, which is with respect to a business parameter, can be used to determine whether to present an offer to provide a lottery ticket. Parameter 162 can be any business parameter known in the art, such as the profitability of a lottery ticket.

In one embodiment, the memory element stores at least one rule 164. In general, rule 164 can be used in place of or in conjunction with the AIP in any or all of the operations described infra and supra regarding the processor or the AIP. For example, the processor can use the rule for the following operations: determining whether to present an offer to provide a lottery ticket and generating the offer.

In one embodiment, the processor generates or modifies rule 164 using the AIP. In another embodiment, the rule is modified using the AIP according to the operations described in the preceding paragraph. Thus, the present invention is self-learning with respect to the rule and the rule can be automatically modified according to feed-back, modifications, or other benchmarks. It should be understood that a modified rule 164 can be used for any or all of the operations described supra or infra for rule 164. Commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007 is applicable to the operation of the AIP and rule 164.

In one embodiment, computer 166, separate from computer 102, transmits modifying rule 168 to computer 102. Computer 166 can be in location 114 (not shown) or can be in a different location. Computer 166 can be associated with a business entity associated with location 114 or can be associated with a different business entity. Connection 170 between computers 108 and 166 can be any type known in the art. In another embodiment (not shown), multiple computers 166 are included and respective computers among the multiple computers can be associated with the same or different business entities. Computer 108 stores modifying rule 168 in memory 104.

In one embodiment, rule 168 is used with or in place of rule 164, or is used in conjunction with the AIP. Commonly owned U.S. patent application Ser. No. 12/151,043, filed May 2, 2008 and entitled “Method and System For Centralized Generation of a Business Executable Using Genetic Algorithms and Rules Distributed Among Multiple Hardware Devices” is applicable to the respective operations of computer 108 with respect to rule 168.

In one embodiment, computer 108 receives at least one modifying rule 172 from a WCD associated with the customer, for example, WCD 130, and stores the rule in memory 104. In one embodiment, rule 172 is used with or in place of rule 168, or is used in conjunction with the AIP. Commonly owned U.S. patent application Ser. No. 12/151,043, filed May 2, 2008 and entitled “Method and System For Centralized Generation of a Business Executable Using Genetic Algorithms and Rules Distributed Among Multiple Hardware Devices” is applicable to the respective operations of computer 108 with respect to rule 172.

In one embodiment, a WCD, for example, WCD 130, with a processor and a memory element, for example, processor 174 and memory 176, is usable to receive an offer, for example, offer 126. The memory element for the WCD stores at least one rule, for example, rule 178 and the processor for the WCD executes the offer according to the rule. Commonly-owned and co-pending U.S. patent application Ser. No. 12/151,040, entitled “METHOD AND SYSTEM FOR MANAGING TRANSACTIONS INITIATED VIA A WIRELESS COMMUNICATIONS DEVICE”, filed May 2, 2008 is applicable to the operations described regarding WCD 130, processor 174, rule 178, and presentation of the offer.

In one embodiment, processor 106, using the AIP or the rules described supra, generates incentive 178 to include with offer 126. For example, the incentive could include a coupon, voucher, or discount on future purchases. The following commonly-owned U.S. patent applications are applicable to the use of the AIP and or the rules described supra to generate an incentive including an offer: U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007; commonly-owned U.S. patent application Ser. No. 12/151,043, titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008; commonly-owned U.S. patent application Ser. No. 12/151,038, titled: “METHOD AND APPARATUS FOR GENERATING AND TRANSMITTING AN ORDER INITIATION OFFER TO A WIRELESS COMMUNICATIONS DEVICE,” inventors Otto et al., filed May 2, 2008; commonly-owned U.S. patent application Ser. No. 12/151,040, entitled “METHOD AND SYSTEM FOR MANAGING TRANSACTIONS INITIATED VIA A WIRELESS COMMUNICATIONS DEVICE”, filed May 2, 2008; commonly-owned U.S. patent application Ser. No. 12/151,042, entitled “METHOD AND SYSTEM FOR GENERATING AN OFFER AND TRANSMITTING THE OFFER TO A WIRELESS COMMUNICATIONS DEVICE”, filed May 2, 2008; commonly-owned U.S. patent application Ser. No. 12/151,042, entitled “METHOD AND SYSTEM FOR GENERATING AN OFFER AND TRANSMITTING THE OFFER TO A WIRELESS COMMUNICATIONS DEVICE”, filed May 2, 2008; commonly-owned U.S. pat. Application entitled “SYSTEM AND METHOD FOR PROVIDING INCENTIVES TO AN END USER FOR REFERRING ANOTHER END USER”, inventors Otto et al., filed Jul. 9, 2008; commonly-owned U.S. pat. Application entitled “METHOD AND SYSTEM FOR GENERATING A REAL TIME OFFER OR A DEFERRED OFFER”, inventors Otto et al., filed Jul. 9, 2008; commonly-owned U.S. pat. Application entitled “METHOD AND APPARATUS FOR GENERATING AND TRANSMITTING AN IDEAL ORDER OFFER”, inventors Otto et al., filed Jul. 9, 2008; commonly-owned U.S. pat. Application entitled “SYSTEM AND METHOD FOR GENERATING AND TRANSMITTING LOCATION BASED PROMOTIONAL OFFER REMINDERS”, inventors Otto et al., filed Jul. 9, 2008; commonly-owned U.S. pat. Application entitled “SYSTEM AND METHOD FOR LOCATION BASED SUGGESTIVE SELLING”, filed Jul. 9, 2008; and commonly-owned U.S. patent application entitled “SYSTEM AND METHOD FOR SCANNING A COUPON TO INITIATE AN ORDER”, filed May 2, 2008.

Any measure or metric known in the art can be used as parameter 138 or 155, including, but not limited to optimizing or maximizing revenues, profits, item counts, average check, market basket contents, marketing offer acceptance, store visitation or other frequency measures, or improving or optimizing speed of service, inventory levels, turns, yield, waste, or enhancing or optimizing customer loyalty or use of kiosks or internet or other POS devices, or use of off peak or other coupons or acceptance of upsell or other marketing offers, or reduction or optimization of any customer or employee or any other person's gaming, fishing, or any other undesirable action or activities and/or failures to act when desired, or minimizing or optimizing any dilution or diversion of sales, profits, average check, or minimizing or optimizing use of discounts and other promotions so as to maximize or optimize any of the foregoing desired actions, outcomes or other desired benefits, or any combination of minimizing undesired results while maximizing or optimizing any one or more of any desired results.

In one embodiment, the system replaces or modifies parameters 138 or 155 using the processor and the AIP or rules discussed supra. For example, the parameter can be modified or replaced in order to enable better attainment of a goal of the business entity presenting the offer. The processor and AIP or rules can use historical, transactional or other data to dynamically make such modifications and replacements in a self-learning and self-modifying manner. For example, the system can actively determine what works best and make modifications and replacements accordingly.

As discussed supra and infra, a present invention system can include some or all of the following functions:
1. The system can perform an identification check of the customer or of a user associated with a WCD device before a lottery is selected, an offer is presented, or a lottery ticket is printed. By means of this check, the system can access data regarding the customer or user that can be used to determine how to select a lottery or whether to present an offer. For example, if the customer or user is legally excluded from eligibility for receiving an offer, for example, due to age of the customer or user, the system can determine that an offer is not be presented. The age of a customer also could be used to select the most appropriate lottery. The age of a customer or user can be determined by any means known in the art, for example, via a credit card used by the customer or user.
2. An offer to purchase a lottery ticket is made for certain payment types and excluded for other payment types. For example an offer can be made only if a credit card was swiped to make the purchase.
3. A customer can pre-register their WCD or method payment, such as a credit card or mobile speed pass (further described infra) so that the customer is pre-registered to receive offers, or so that respective offers are automatically presented as part of their purchases at a retailer. The pre-registration also can address types of lotteries the customer may or may not wish to receive.
4. A customer can pre-swipe a personal identification, particularly while a transaction is processing, so that they are pre-qualified to receive and or automatically accept lottery ticket offers at the end of the transaction.
5. A lottery ticket offer made at a gas pump that is accepted prints a lottery ticket inside the store. The lottery ticket could have the credit card number printed on it to identify that ticket when the customer comes in to pick it up.
6. If a lottery ticket is purchased as part of a transaction, the system can refrain from presenting an offer as part of the transaction.
7. If a lottery ticket offer is made and not accepted after a specified time period, the system can cancel the offer. The time period can be determined by the processor, for example, processor 106, and an AIP, for example, AIP 110 based on information regarding the customer, transactional histories, or effectiveness of previous time periods.
8. Lottery tickets can be transmitted electronically to an end user device, for example, WCD 130, rather than being printed, for example, at a kiosk.
9. If a lottery ticket is not successfully generated at the pump, the ticket can be reprinted inside the store.
10. A WCD device usable with the system can include a mobile speed pass, for example, devices that are placed near or on a sensor at a fuel pump to initiate a fueling operation and that provide a user/owner name and account information to be used to bill the user/owner for the fueling operation.

Commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007, is applicable to the operations involving the AIP or any rules, noted supra and infra.

In one embodiment, the operations of the processor and the AIP, described supra and infra, include the generation of executables as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

It should be understood that various storage and removal operations, not explicitly described above, involving memory 104 and as known in the art, are possible with respect to the operation of system 100. For example, outputs from and inputs to the general-purpose computer can be stored and retrieved from the memory elements and data generated by the processor can be stored in and retrieved from the memory.

It should be understood that system 100 can be operated by the same business entity operating or owning a business location using the system, or can be operated by a third party different than the business entity operating or owning the business location using the system. In one embodiment, a third party operates system 100 as disclosed by commonly-owned U.S. patent application Ser. No. 11/985,141: “UPSELL SYSTEM EMBEDDED IN A SYSTEM AND CONTROLLED BY A THIRD PARTY,” inventors Otto et al., filed Nov. 13, 2007.

It should be understood that system 100 can be integral with a computer operating system for a business location, for example, location 114 or with a business entity operating the business location. It also should be understood that system 100 can be wholly or partly separate from the computer operating system for a retail location, for example, location 114, or with a business entity operating the business location.

It should be understood that although individual rule sets and a single artificial intelligence program are discussed, various of the individual rule sets can be combined into composite rules set (not shown). Further, the functions described for AIP 110 can be implemented by combinations of separate AIPs (not shown). Any combination of individual rule sets or artificial intelligence programs is included in the spirit and scope of the claimed invention.

In general, system 100, and in particular, the processor using the AIP, operates to use artificial intelligence, for example, a generic algorithm, to inform or make some or all of the decisions discussed in the description for FIG. 1. In one embodiment, system 100 performs the operations described herein to attain or maximize an objective of a business entity, for example, performance with respect to parameter 138 or 155. Factors usable to determine an objective can include, but are not limited to: customer acceptance rate, profit margin percentage, customer satisfaction information, service times, average check, inventory turnover, labor costs, sales data, gross margin percentage, sales per hour, cash over and short, inventory waste, historical customer buying habits, customer provided information, customer loyalty program data, weather data, store location data, store equipment package, POS system brand, hardware type and software version, employee data, sales mix data, market basket data, or trend data for at least one of these variables. Thus, the present invention, for example, system 100, specifically, computer 102 and processor 106, use artificial intelligence, for example, AIP 110 to automatically generate or modify operations, parameters, and outputs with respect to a goal, for example, a metric such as parameter 138 or 155 and automatically adapts the generation or modification operations, parameters, and outputs to feedback, that is, the present invention is self-learning and self-adapting with respect to generating or modifying operations, parameters, and outputs. Further, the present invention can automatically generate or modify the goal and be self-learning and self-adapting with respect to the goal.

A present invention method also can be described as follows. For a central system, for example, computer 108, the following steps can be executed: identification check before printing ticket; process transaction; output offer; receive offer acceptance; output identification request; receive identification; and print ticket. For a central system and a credit card transaction, the following steps can be executed: receive a request to make a transaction, including a credit card for payment; generate offer; and output offer. For a central system and identification swipe prompt during transaction, the following steps can be executed: receive a request to make a transaction; process transaction; output offer to scan identification; receive identification scan; receive indication that transaction is complete; output offer for ticket; receive offer acceptance; and print ticket.

For a central system, an offer is suppressed if lottery ticket already in transaction, and the following steps can be executed: receive transaction information; determine if transaction includes ticket; if transaction includes ticket, suppress offer; if transaction does not include ticket, output offer. For a central system to modify transaction score, the following steps can be executed: receive transaction data; retrieve transaction scores; and alter scores based on transaction data. For a central system to score transaction for offer, the following steps can be executed: receive transaction data; score transaction; generate offer based on score; output offer; receive and store offer accept/decline. For a central system to cancel offer after x time period, the following steps can be executed: receive transaction; output offer; and automatically decline offer after x time period if offer is not accepted or declined.

For a central system to check age of holder of swiped credit card and offer ticket if age is allowable, the following steps can be executed: receive transaction request including credit card; determine if credit card is registered to a qualified party; and output offer if credit card is registered to a qualified party. For a central system to automatically accept offer, the following steps can be executed: receive end user identification; process transaction; determine if end user auto accepts offer; process offer (to buy a lottery ticket for coin change due, or just a lottery ticket); and complete transaction.

A present invention method also can be described as follows. For an end user device, for example, WCD 130, the following steps can be executed: register to receive/accept offers; receive offer preference data; and store preference data. For an end user device, for example, WCD 130, to automatically accept offers based on preference data, the following steps can be executed: output identification to initiate transaction; and output offer preference.

The present invention includes a self-learning method for providing a lottery ticket at a point of sale device. Although the method is depicted as a sequence of steps for clarity, no order should be inferred from the numbering unless explicitly stated. The method: stores, in a memory element for at least one specially programmed computer, an artificial intelligence program (AIP); implements a retail transaction with a business entity using a point of sales (POS) device in communication with the at least one specially programmed computer; and determines, using a processor for the at least one specially programmed computer, whether an amount due for goods or services included in the retail transaction includes a coin amount with a value less than one dollar.

For a retail transaction with a coin amount the method: identifies, using the processor, an item or service included in the retail transaction; determines, using the processor, an identification of a customer for the retail transaction; identifies, using the processor, a payment method for the retail transaction; and determines, using the processor, the AIP, the identification of the item or service included in the retail transaction, the identification of the customer involved in the retail transaction, and the identification of the payment method for the retail transaction, whether to present an offer to provide a lottery ticket for a lottery from at least one lottery. For a determination to present the respective offer, the method: determines, using the processor, a change amount equal to a difference between one dollar and the coin amount; generates, using the processor and the AIP, the offer, the offer including the provision of the lottery ticket in lieu of providing the change amount; and transmits, using an interface device for the at least one specially programmed computer, the offer for presentation by the POS device.

In one embodiment, the at least one lottery includes a plurality of lotteries and the method, for a determination to present the respective offer, selects, using the processor and the AIP, a first lottery from the plurality of lotteries and generating the offer, the offer including the provision of the lottery ticket in lieu of providing the change amount, includes generating the offer for the provision of a lottery ticket for the first lottery.

In one embodiment, a step implements a plurality of said retail transactions with the business entity using at least one POS) device in communication with the at least one specially programmed computer and another step determines, using the processor, whether a respective amount due for respective goods or services included in each retail transaction included in the plurality of retail transactions includes a respective coin amount with a value less than one dollar. For said each retail transaction with a coin amount, the method: identifies, using the processor, a respective item or service included in each retail transaction included in the plurality of retail transactions; determines, using the processor, an identification of a respective customer for said each retail transaction; determines, using the processor, a respective amount due for goods or services included in said each retail transaction, the respective amount due including a respective coin amount with a value less than one dollar; identifies, using the processor, a respective payment method for said each retail transaction; determines, using the processor, the AIP, the identification of the respective item or service included in said each retail transaction, the identification of the respective customer for said each retail transaction, and the identification of the respective payment method for said each retail transaction, whether to present a respective offer to provide a respective lottery ticket for a respective lottery from the least one lottery. For a determination to present the respective offer, the method: determines, using the processor, a respective change amount equal to a difference between one dollar and the respective coin amount; generates, using the processor and the AIP, the respective offer, the respective offer including the provision of the respective lottery ticket in lieu of providing the respective change amount; and transmits, using an interface device for the at least one specially programmed computer, the respective offer for presentation by the at least one POS device. The method also compiles, using the processor, an offer transaction history including information related to acceptance and refusal of the respective offers. Determining whether to present an offer to provide a lottery ticket includes using the offer transaction history.

In one embodiment, the at least one lottery includes a plurality of lotteries and the method, for a determination to present the respective offer, selects, using the processor and the AIP, a respective lottery from the plurality of lotteries. Generating the respective offer, the offer including the provision of the respective lottery ticket in lieu of providing the respective change amount, includes generating the respective offer for the provision of a lottery ticket for the respective lottery. The method compiles, using the processor, an offer transaction history including information related to acceptance and refusal of the respective offers, and selecting, using the processor and the AIP, a respective lottery from the plurality of lotteries includes using the processor, the AIP, and the offer transaction history to select the respective lottery.

In one embodiment, the method evaluates, with respect to a parameter, and using the processor and the AIP, the identification of the item or service included in the retail transaction, the identification of the customer for the retail transaction, or the identification of the payment method for the retail transaction. Determining whether to present an offer to provide a lottery ticket includes using the evaluation with respect to the parameter.

In one embodiment, the method accesses, using the processor, a payment method transaction history regarding at least one transaction previously enacted with the business entity using the payment method and determining whether to present an offer to provide a lottery ticket includes using the payment transaction history.

In one embodiment, the method accesses using the processor, a customer transaction history regarding transactions previously enacted between the customer and the business entity and determining whether to present an offer to provide a lottery ticket includes using the customer transaction history.

In one embodiment, the method accesses, using the processor, a retail transaction history regarding at least one transaction previously enacted with the business entity and including the item or service and determining whether to present an offer to provide a lottery ticket includes using the retail transaction history.

In one embodiment, when the payment method is other than a credit card, determining whether to present an offer to provide a lottery ticket includes determining not to provide an offer.

The present invention includes a self-learning method for providing a lottery ticket at a point of sale device. Although the method is depicted as a sequence of steps for clarity, no order should be inferred from the numbering unless explicitly stated. The method: stores, in a memory element for at least one specially programmed computer, an artificial intelligence program (AIP); implements a plurality of retail transactions with a business entity using at least one point of sales (POS) device in communication with the at least one specially programmed computer; determines, using a processor for the at least one specially programmed computer, whether a respective amount due for goods or services included in each retail transaction in the plurality of retail transactions includes a respective coin amount with a value less than one dollar.

For a retail transaction with a coin amount, the method: identifies, using a processor for the at least one specially programmed computer, a respective item or service included in each retail transaction included in the plurality of retail transactions; determines, using the processor, an identification of a respective customer involved in said each retail transaction; identifies, using the processor, a respective payment method used for said each retail transaction; evaluates, with respect to a parameter, and using the processor and the AIP, the identification of the respective item or service included in said each retail transaction, the identification of the respective customer for said each retail transaction, and the identification of the respective payment method used for said each retail transaction; and determines, using the processor, the AIP, and the evaluation with respect to the first parameter, whether to present a respective offer to provide a respective lottery ticket for a respective lottery from the at least one lottery.

For a determination to present the respective offer, the method: determines, using the processor, a respective change amount equal to a difference between one dollar and the respective coin amount; generates, using the processor and the AIP, the respective offer, the respective offer including the provision of the respective lottery ticket in lieu of providing the respective change amount; and transmits, using an interface device for the at least one specially programmed computer, the respective offer for presentation by the at least one POS device. The method compiles, using the processor, an offer transaction history including information related to acceptance and refusal of the respective offers. Evaluating, with respect to a first parameter, includes evaluating the offer transaction history; or determining whether to present a respective offer to provide a respective lottery ticket includes using the offer transaction history.

Although the following non-limiting discussion is directed to a present invention system, it is understood that the discussion also is applicable to a present invention method. The present invention leverages existing or future marketing systems, marketing programs, loyalty programs, sponsor programs, coupon programs, discount systems, incentive programs, or other loyalty, marketing, or other similar systems, collectively, “marketing systems” by adding programming logic, self-learning, and self-adaptation to generate or modify an offer, for motivating a desired behavior by a customer. The present invention can use any, all, or none of the following considerations as part of generating or modifying an offer, incentive, or parameter, or performing the operations described supra, for example, by adding programming logic, self-learning, and self-adaptation as noted supra: any one or more data or variables available or accessible, including, for example, any customer, business or sponsor information, such as, membership in a loyalty or other marketing program, ordering preferences or history, current sales volumes or budgets or targets, current or planned local, regional or national marketing programs or objectives, device preferences, current speed of service, quality of service or other operating data, budgets, objectives or trends, etc.

In one embodiment, the present invention employs any, all, or none of the following considerations as part of generating or modifying lottery selections, offers, identifications, histories, incentives, or other parameters or performing the operations described supra, for example, by adding programming logic, self-learning, and self-adaptation as noted supra:
1. Parameters or data regarding a customer, for example, history 122. For example, an offer can be made only if the customer is a loyal customer. Customer objectives also can be considered.
2. Temporal parameters, such as the time of day, week, month, or year.
3. The good or service involved in a past, current, or possible future transaction between the customer and the business entity.
4. Specifics of a transaction. With the use of the AIP, system 100 can automatically, dynamically, and intelligently adapt an offer to any parameter associated with a particular transaction. Further, the parameters to which the system is to adapt the offer can be automatically, dynamically, and intelligently selected or modified.
5. Physical parameters of the transaction process. For example: order entry device, e.g., type of POS device or WCD: terminal, kiosk, cell phone, PDA, laptop, IED, etc.; POS device or station, e.g., front counter, drive through, retail station, call center, location on counter, e.g., first station vs. second, third fourth or other station, etc.; output display device (e.g., customer facing display, kiosk, cell phone, PDA, laptop, IED, etc.); or in a quick serve restaurant, an offer can be used to encourage use of self-service kiosks, which may optimize revenue for the business entity, or to discourage use of a point of sales station attended by an employee.
6. Rate of sale of items. For example, offers can be withheld for transactions for goods that are selling rapidly or presented for goods that are selling slowly.
7. Regular orders. For example, based on the transaction history, an offer can be presented for transactions for items regularly ordered by a customer or for transactions for items rarely ordered by a customer to encourage the customer to order the rarely ordered items.
8. The nature of the transaction.
9. The location at which the transaction is occurring, for example, presenting offers to encourage patronage at a location.
10. Business Information or objectives, for example, parameter 138 or 155.
11. Sponsor Information or objectives.
12. Marketing Program Type.
13. Opt In Information.
14. Payment method or terms or conditions of payment.
15. Marketing Message Contents.
16. Marketing Offer Objectives.
17. Expected or Actual System Results or tracking data.
18. One or more table entries provided by one or more end users, for example, a system administrator.
19. One or more rules provided by one or more end users, for example, a system administrator.
20. One or more genetic algorithms or other AI based rules or determination methods.
21. Point within transaction, e.g., pre-order, mid-order, post order, etc.
22. Loyalty program information.
23. Current store activity, e.g., high or low volumes of transactions.
24. Customer survey information.
25. Financial considerations, such as total current price/profit, total expected price/profit, regular or discounted price, gross margins, profit margins, labor rates, labor availability, marketing funds available, or third party funds available, budget.
26. Expectation of accept or reject of one or more offers.
27. Current, prior or expected level of dilution, gaming, fishing, accretion.
28. Business, customer, or employee target goals.
29. Current or planned local, regional or national or other marketing campaigns, including, for example, product introductions, price or other promotions, print, radio or television or other advertisements, e.g., newspaper coupon drops, etc.
30. Business, customer, sponsor, or system objectives.
31. Business, customer, sponsor, third party, or system information.
32. Any other information, data, rules, system settings, or otherwise available to the system or disclosed invention.
33. Any combination or priority ranking of any two or more of the foregoing.

In one embodiment, the self learning system selects, generates, or modifies lottery selections, offers, identifications, histories, incentives, or other parameters based on the performance of one or more of the following parameters:
1. Complaints registered by consumers regarding previous offers.
2. Acceptance or rejection rates of previous offers.
3. The profitability of the customer or class of customers associated with presentation, acceptance or rejection of previous offers.
4. The revenue and or profit generated by the business entity as a result of offers.
5. The subsidy a third party is willing to provide for lottery tickets or rewards associated with a lottery.
   Although specific parameters are noted above, it should be understood that other parameters are within the spirit and scope of the claimed invention.

In one embodiment, lottery selections, offers, identifications, histories, incentives, or other parameters, are created or maintained centrally or in a distributed network, including, for example, locally. Such management may be accomplished via any applicable means available, including, for example, making use of existing, e.g., off the shelf or customized tools that provide for such creating, management or distribution.

In another embodiment, in an effort to further enhance generating or modifying lottery selections, offers, identifications, histories, incentives, or other parameters, or to otherwise improve one or more aspects of the present invention, the invention may access certain information from existing systems, including, for example, existing POS databases, such as customer transaction data, price lists, inventory information or other in or above store, for example, location data, including, but not limited to data in a POS, back office system, inventory system, revenue management system, loyalty or marketing program databases, labor management or scheduling systems, time clock data, production or other management systems, for example, kitchen production or manufacturing systems, advertising creation or tracking databases, including click through data, impressions information, results data, corporate or store or location financial information, including, for example, profit and loss information, inventory data, performance metrics, for example, speed of service data, customer survey information, digital signage information or data, or any other available information or data, or system settings data.

In one embodiment, each location associated with the present invention establishes its own rules, uses its own AIP or generic algorithm, or learns from local customer behavior or other available information. In another embodiment, the present invention shares some or all available information or results data among any two or more or all locations or locations that fall within a given area, region, geography, type, or other factors, such as customer demographics, etc., and makes use of such information to improve the present invention's ability to perform present invention operations described supra and infra.

For example, when using an AI based system, such as disclosed in commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007,” one location may discover or otherwise determine that a certain type or class of lottery selections, offers, identifications, histories, incentives, or other parameters are particularly effective. By sharing such information among other locations, for example, similar locations, the present invention can begin to make use of the same or similar lottery selections, offers, identifications, histories, incentives, or other parameters in other generally similar locations or with similar customers or classifications of customers so as to improve the performance of one or more other such locations or all locations. In this fashion, the present invention can learn which lottery selections, offers, identifications, histories, incentives, or other parameters generally achieve the desired results or improve trends towards such results. Likewise, the present invention can more quickly determine which lottery selections, offers, identifications, histories, incentives, or other parameters do not yield the desired results or determine how long such lottery selections, offers, identifications, histories, incentives, or other parameters are required to achieve the desired results.

In one embodiment, offers or incentives are provided or subsidized by one or more third parties, including, for example, third party sponsors. For example, a third party could fund a lottery as an opportunity to provide advertising on a ticket for the lottery.

In one embodiment, customers are grouped by the processor according to similarities in transaction history or other customer information, for example, using history 122. The system generates, modifies, or uses lottery selections, offers, incentives, or other parameters per the grouped customers.

In one embodiment, the present invention generates, modifies, or uses lottery selections, offers, incentives, or other parameters based upon other performance data or results, for example, identification 120, 122, or 124, or histories 158 or 160. In another embodiment, the present invention determines the impact of lottery selections, offers, identifications, histories, incentives, or other parameters on the ability or proclivity of an employee or customer to game or fish the present invention. The system avoids or ceases lottery selections, offers, identifications, histories, incentives, or other parameters and/or changes the type of lottery selections, offers, identifications, histories, incentives, or other parameters provided or suppressed.

In one embodiment, lottery selections, offers, identifications, histories, incentives, or other parameters vary from customer to customer or from time to time, or one or more of these may be consistent regardless of the customer, time, or other information. In a another embodiment, where lottery selections, offers, identifications, histories, incentives, or other parameters vary, such lottery selections, offers, identifications, histories, incentives, or other parameters are determined via any applicable means and using any available information to make such determination, including, for example, any available customer, account, business, or sponsor information or any one or more customer, account, business, or sponsor objectives or any combination of the forgoing. In a further embodiment, lottery selections, offers, identifications, histories, incentives, or other parameters are further determined or modified based upon information or needs or business objectives of one or more suppliers or competitors of such suppliers.

For example, if a WCD is within a geographical area for a location selling competing items A and B, an offer related to a retail transaction including one or both of the items is underwritten by vendors for the items. In one embodiment, one or more of the above operations are performed using the AIP.

In one embodiment, a present invention system generates, modifies, or uses lottery selections, offers, identifications, histories, incentives, or other parameters based upon current or previous buying habits or any other available information regarding a customer. If for example, an end user is a loyal customer for item A, the present invention can include an offer and incentive for a retail transaction including item A, or eliminate the incentive for a retail transaction including a different item depending upon any known factors. In this fashion a competitive environment is created.

In one embodiment, the end user of a present invention system modifies the rules or method of operation so as to favor itself. For example, in the previous example, if the producer of item A were the sole end user of the present invention, the producer may choose to not share any part or all of any such customer information or may use knowledge of any reminder regarding item B to its benefit. In another example, if a grocery chain was the sole end user of the present invention, the end user may choose to provide equal access to the present invention or favor one or more of its suppliers based upon any one or more of its business objectives, for example, the profitability or perceived or actual quality or consistency or pricing of such one or more suppliers. In one embodiment, one or more of the above operations are performed using the AIP.

In one embodiment, in order to receive an offer or incentive, customers are required to opt in to a cellular marketing program or some other loyalty program indicating their desire or providing permission for such marketing system or the business entity to send one or more such agreement or incentive. In this fashion, only those interested in such communications will be sent such communications.

In a further embodiment, an offer or incentive is modified for prospective customers having an identity previously provided by an existing customer, as described in commonly-owned U.S. patent application Ser. No. 12/217,863, titled: “SYSTEM AND METHOD FOR PROVIDING INCENTIVES TO AN END USER FOR REFERRING ANOTHER END USER,” inventors Otto et al., filed Jul. 9, 2008, which application is incorporated by reference herein. For example, if an existing quick service restaurant chain customer provides one or more prospective customer's identity, when such prospective customer is identified during a transaction with a quick service restaurant chain's participating location, the present invention generates or modifies an offer or incentive or presentation of an offer or incentive to encourage participation in the program and provides the identity of the referring party along with such agreement or incentive. In one embodiment, one or more of the above operations are performed using the AIP.

In one embodiment, the present invention improves results over time or with use of the invention. Such improvement or optimization can be accomplished via any means necessary including any of several methods well known in the art or as disclosed by applicants and incorporated herein by reference, including, for example, commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007; commonly-owned U.S. patent Application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008; and commonly-owned U.S. patent Application titled: “METHOD AND APPARATUS FOR GENERATING AND TRANSMITTING AN ORDER INITIATION OFFER TO A WIRELESS COMMUNICATIONS DEVICE,” inventors Otto et al., filed May 2, 2008. For example, statistical methods can be used to determine which offers, incentives, or presentations generally yield the desired or optimal or generally better results, or such results may be determined using artificial intelligence, for example, one or more genetic algorithms, or a present invention administrator/operator can review results reports and then provide manual weighting criteria to further define or control the present invention, or a combination of these and other well known methods may be employed in any combination or in any order or priority.

In one embodiment, a present invention incentive includes a discount on a offer for a lottery ticket. In one embodiment, discounts are determined based upon rules established by management of the present invention or as established or modified from time to time by any authorized personnel, or may be initially established or modified using a learning system, e.g., a genetic algorithm. In any such case, the present invention can make use of any or all available information, including, but not limited to transaction history and customer information. Discounts can be designed to maximize, minimize or optimize any one or more business or customer objectives as desired or indicated. In another embodiment, the discount, if any, is presented to the customer as a percentage discount or as a cents or other amount off discount. In one embodiment, one or more of the above operations are performed using the AIP.

In one embodiment, discounts in incentives are used/tried relatively sparingly to determine the price elasticity of customers, both as a whole and/or by class, group, demographics, type or order contents, base order amounts, and/or specific customer's buying habits and acceptance/rejection information. In this fashion, the present invention can, over time, yield optimal results by learning or otherwise determining what price reductions, if any, are required given the known information. For example, if a customer has not responded to an offer for a lottery ticket, the present invention could include a discounted ticket in an incentive. If the customer rejects such offer, the present invention could offer a larger discount in the incentive. Once the present invention determines an offer acceptor's price points, and/or an acceptor becomes habituated to accepting offers, the present invention can reduce or eliminate related discounts or other incentives. In one embodiment, one or more of the above operations are performed using the AIP.

In one embodiment, the present invention, having acquired data regarding customer price elasticity, compliance, or other information, uses such information to determine other offers, incentives, or presentations for the same or generally similar customers, e.g., other customers who fail to accept a type of offer. In another embodiment, using such logic, the present invention determines classifications of customers and leverage use of such information by providing offers, incentives, or presentations that also are optimized from the location or location management perspective/objectives. In one embodiment, one or more of the above operations are performed using the AIP.

In one embodiment, an administrator can add or change or otherwise modify the previous listing, or data, or determine the order of priority or preference of each such discrimination factors or preferences or data, including, for example, location, payment or device, ranking each in order of such preference or providing table, rules or other entries to provide or assist or to support determining which are preferred or the amount of incentive available or increased or decreased incentive, as a percentage or absolute or relative or other dollar or other calculation method to determine what price modifications, if any to make, at which locations, devices or payment methods or other discriminating factors, for example, customer or business preferences or customer, business, sponsor or other entity information, objectives, rules or other available information or rules or system settings. By providing or otherwise manually or automatically determining such rankings, the disclosed invention can initially or continuously evaluate potential pricing and modify such pricing or provide other incentives to drive a desired percentage of business or customer transactions to one or more particular devices, locations or payment methods. In one embodiment, one or more of the above operations are performed using the AIP.

In one embodiment, the present invention provides such incentives initially, or on an ongoing basis or only until certain objectives are achieved or certain customers or all customers are generally habituated to acceptance of offers, after which, in certain embodiments, the present invention may cease, temporarily or permanently making such price incentives based upon such discriminating factors, or may reduce the difference in incentives, or may only periodically provide such full discounts or reduced discounts so as to reinforce such behavior. In another embodiment, a system administrator or other end user establishes such rules or conditions. In one embodiment, one or more of the above operations are performed using the AIP.

In one embodiment, the present invention makes such determinations using an automated means. Such automated means includes, for example, a system that periodically or generally continuously tests different transaction histories, offers, incentives, or presentations or other methods, for example, user interfaces, or other benefits or incentives, and based upon such testing, determine which transaction histories, offers, incentives, or presentations or other benefits yield the desired compliance, for example, with a business objective. Such automated system may periodically cease providing such incentives once it is determined that the desired customer behavior has been established, habituated or otherwise persists without need for such continued incentive. If such system subsequently determines that the desired behavior has ceased or fallen below a desired level, such system can then reinstate an appropriate incentive. When reinstating such incentive, the present invention can return to previously successful levels, or can provide different transaction levels on a temporary, periodic or permanent basis. Such reinstatement may be provided for all customers, certain customers, classes of customers, or only those customers that have ceased or have generally reduced their frequency of desired behavior. In one embodiment, one or more of the above operations are performed using the AIP.

In one embodiment, the present invention tests transaction histories, offers, incentives, or presentations or provides certain pricing on a periodic basis within a single location or among a plurality of locations so as to determine the extent or requirement regarding any such transaction histories, offers, incentives, or presentations or other benefits. For example, by testing incentive levels, the present invention can determine the level of incentive needed to attain a business goal, or such a system can further determine the extent of any gaming, dilution, diversion or accretion. By alternating offering and not offering incentive modification or by testing various levels of incentives, the present invention can better determine the optimal incentive, discount or benefits required, if any, to achieve the desired results, while minimizing or mitigating any undesirable effects of using or deploying such system. Such testing can be accomplished via any applicable or available means, including those previously disclosed by applicants herein and within the referenced applications, or randomly or using rules or AI based systems. By periodically testing or making changes to such transaction histories, account data, metrics, desired transactions, offers, incentives, presentations or benefits, the present invention can continually strive to achieve the optimal mix and level of transaction histories, offers, incentives, or presentations. By combining the use of one or more of a table, rules or AI based system, including, for example, as disclosed in the applications incorporated by reference herein, a more effective, responsive, adaptive, and dynamic marketing system may be developed and deployed that achieves optimal or nearly optimal results over both the short and long term.

In one embodiment, the present invention tests customers of one or more locations using, an incentive, for example, discounted pricing, while maintaining the regular prices at one or more other locations. By comparing the results data from such test and control groups of locations, the present invention can better determine which incentives are accretive or provide net benefit or are subject to gaming, fishing or other fraudulent or undesirable activities. Such testing can be performed within a single unit as well, by periodically offering such incentives to the same or similar customers or by randomly providing or not providing such incentives. In one embodiment, one or more of the above operations are performed using the AIP.

In one embodiment, the present invention makes use of a combination of such testing methodologies in order to best determine which offers, incentives, or presentations yield optimal or the best results given the present invention information, parameters or any one or more customer, business, sponsor or present invention objectives. For example, the present invention tests in a single or group of stores certain new or untested offers, incentives, or presentations, and, combines such test with a periodic modification of offers, incentives, or presentations, for example, toggling, between higher and lower price discounts, which toggling, may be random, 50/50, or may be intelligently determined, for example, using the AIP, based upon system information, and continue such test for a period of time, for example, one month, while comparing results of such tests with a similar number of stores in a control group, and then, switch the process, for example, test within the original control group and stop offering modified agreements, incentives, or presentations within the original test group. In this fashion the present invention determines the effects of offers, incentives, or presentations modifications and the effect of such modifications on customers, customer buying habits, store or business results, or any other measures, including, for example, testing for dilution, diversion, accretion, gaming or fishing. In one embodiment, one or more of the above operations are performed using the AIP.

In one embodiment, a system administrator is able to enter or modify or delete or otherwise provide transaction histories, offers, incentives, or presentations using an interface provided for such purposes. When establishing messages or content of transaction histories, offers, incentives, or presentations, such administrator or other end user may be further permitted to designate which transaction histories, offers, incentives, or presentations are to be generally used when using a particular type of communications. For example, one type of transaction history, offers, incentives, or presentations may be designated for use when communicating via cell phone and another transaction history, offers, incentives, or presentations used for email and still other versions for each or all of the other various methods of communications. In another embodiment, the present invention tests each transaction history, offers, incentives, or presentations with each such communications method to determine, partially or wholly, which transaction history, offers, incentives, or presentations yields the best or optimal results over time or based upon any available information, including, for example, any available or otherwise accessible customer, business or sponsor information or objectives or by tracking actual activities and results or changes in behavior as expected or predicted by customers or other end users or classes or categories of uses or by device, location or payment method. In a further embodiment, one or more of the above operations are performed using the AIP.

The following is a listing of exemplary hardware and software that can be used in a present invention method or system. It should be understood that a present invention method or system is not limited to any or all of the hardware or software shown and that other hardware and software are included in the spirit and scope of the claimed invention.

1. Hardware:

a. Central Controller or Local Controllers. The present invention can be managed by a central system on behalf of multiple business entities or locations or systems associated with portions of the multiple business entities or locations can implement the present invention. Generate and print/distribute lottery tickets based on accepted offers.

b. Retailer System 1-n: Generate and display/distribute offers. Generate and print/distribute lottery tickets based on accepted offers.

c. End User Device 1-n: Register with program to receive offers—receive ticket preferences from end user. Accept and pay for offers for end user.

2. Software:

a. Offer Program: generates offers; modifies offers, for example, based on transaction histories; generates and modifies presentations for offers; accepts acceptances of offers. Uses artificial intelligence, for example, generic algorithms, as applicable.

b. Incentive Program: generates incentives; modifies incentives, for example, based on transaction histories; generates and modifies presentations for incentives; and manages incentives.

The following is a listing of exemplary data bases that can be used in a present invention method or system. It should be understood that a present invention method or system is not limited to any or all of the databases shown and that other databases are included in the spirit and scope of the claimed invention:

Central System:

Retailer Database-stores data about each retailer

Transaction Database-stores transaction information including tickets sold and transaction score.

Registered End User Database-stores end user information.

Lottery Ticket Database-stores tickets available and sold information.

Payment Types Database-stores various types of payment and rules for offering tickets based on types.

Transaction Score Database-a list of scores that can be applied against a given transaction to determine the optimal offer to make for that transaction.

It is to be understood that the embodiments and variations shown and described herein are merely illustrative of the principles of this invention and that various modifications may be implemented by those skilled in the art without departing from the scope and the spirit of the invention. For example, while the invention has been illustrated as being implemented using particular computer systems including hardware components such as a computer, POS terminals, portable employee terminals, and input and output devices, the invention could also be implemented using other hardware components and/or other interconnections between such components. Also, while the invention has been described as being implemented using a computer, some or all of the functionality could alternatively reside in a POS terminal or other computing device (e.g., a headset). The invention could also be implemented using discrete hardwired components instead of computers. Further, while the above description refers to particular databases, other databases or data structures could be used. In addition, while various embodiments of methods in accordance with the invention have been discussed which include specific steps listed in specific orders, a person of skill in the art will recognize that these steps can be performed in different combinations and orders. While other modifications will be evident to those skilled in the art, the present invention is intended to extend to those modifications that nevertheless fall within the scope of the appended claims.

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

What is claimed is:

1. A self-learning method for providing a lottery ticket at a point of sale device, comprising:
storing, in a memory element for at least one specially programmed computer, an artificial intelligence program (AIP);
implementing a retail transaction with a business entity using a point of sales (POS) device in communication with the at least one specially programmed computer;
determining, using a processor for the at least one specially programmed computer, whether an amount due for goods or services included in the retail transaction includes a first coin amount with a value less than one dollar; and,
for a retail transaction with the first coin amount:
identifying, using the processor, an item or service included in the retail transaction;
determining, using the processor, an identification of a customer for the retail transaction;
identifying, using the processor, a payment method for the retail transaction; and,
determining, using the processor, the AIP, the identification of the item or service included in the retail transaction, the identification of the customer involved in the retail transaction, and the identification of the payment method for the retail transaction, whether to present an offer to provide a lottery ticket for a lottery from at least one lottery; and,
for a determination to present the offer:
determining, using the processor, a change amount equal to a difference between one dollar and the first coin amount;
generating, using the processor and the AIP, the offer, the offer including the provision of the lottery ticket in lieu of providing the change amount; and,
transmitting, using an interface device for the at least one specially programmed computer, the offer for presentation by the POS device.

2. The method of claim 1 wherein the at least one lottery includes a plurality of lotteries and the method further comprising, for a determination to present the respective offer, selecting, using the processor and the AIP, a first lottery from the plurality of lotteries, wherein generating the offer, the offer including the provision of the lottery ticket in lieu of providing the change amount, includes generating the offer for the provision of a lottery ticket for the first lottery.

3. The method of claim 1, further comprising:
implementing a plurality of said retail transactions with the business entity using at least one POS device in communication with the at least one specially programmed computer; and,
determining, using the processor, whether a respective amount due for respective goods or services included in each retail transaction included in the plurality of retail transactions includes respective first coin amounts;
for said each retail transaction with a first coin amount:
identifying, using the processor, a respective item or service included in each retail transaction included in the plurality of retail transactions;
determining, using the processor, an identification of a respective customer for said each retail transaction;
determining, using the processor, a respective amount due for goods or services included in said each retail transaction, the respective amount due including a respective first coin amount with a value less than one dollar;
identifying, using the processor, a respective payment method for said each retail transaction;
determining, using the processor, the AIP, the identification of the respective item or service included in said each retail transaction, the identification of the respective customer for said each retail transaction, and the identification of the respective payment method for said each retail transaction, whether to present a respective offer to provide a respective lottery ticket for a lottery from the at least one lottery; and,
for a determination to present the respective offer:
determining, using the processor, a respective change amount equal to a difference between one dollar and the respective first coin amount;
generating, using the processor and the AIP, the respective offer, the respective offer including the provision of the respective lottery ticket in lieu of providing the respective change amount; and,
transmitting, using an interface device for the at least one specially programmed computer, the respective offer for presentation by the at least one POS device; and,
compiling or updating, using the processor, an offer transaction history including information related to acceptance or refusal of the respective offers, wherein determining whether to present an offer to provide a lottery ticket includes using the offer transaction history.

4. The method of claim 3 wherein the at least one lottery includes a plurality of lotteries and the method further comprising, for a determination to present the respective offer, selecting, using the processor and the AIP, a respective lottery from the plurality of lotteries, wherein generating the respective offer, the offer including the provision of the respective lottery ticket in lieu of providing the respective change amount, includes generating the respective offer for the provision of a lottery ticket for the respective lottery, the method further comprising compiling or updating, using the processor, an offer transaction history including information related to acceptance or refusal of the respective offers, wherein selecting, using the processor and the AIP, a respective lottery from the plurality of lotteries includes using the offer transaction history to select the respective lottery.

5. The method of claim 1 further comprising evaluating, with respect to a parameter, and using the processor and the AIP, the identification of the item or service included in the retail transaction, the identification of the customer for the retail transaction, or the identification of the payment method for the retail transaction, and wherein determining whether to present an offer to provide a lottery ticket includes using the evaluation with respect to the parameter.

6. The method of claim 1 further comprising accessing, using the processor, a payment method transaction history regarding at least one transaction previously enacted with the business entity using the payment method and wherein determining whether to present an offer to provide a lottery ticket includes using the payment transaction history.

7. The method of claim 1 further comprising accessing, using the processor, a customer transaction history regarding transactions previously enacted between the customer and the business entity and wherein determining whether to present an offer to provide a lottery ticket includes using the customer transaction history.

8. The method of claim 1 further comprising accessing, using the processor, a retail transaction history regarding at least one transaction previously enacted with the business entity and including the item or service and wherein determining whether to present an offer to provide a lottery ticket includes using the retail transaction history.

9. The method of claim 1 wherein when the payment method is other than a credit card, determining whether to present an offer to provide a lottery ticket includes determining not to provide an offer.

10. A self-learning method for providing a lottery ticket at a point of sale device, comprising the steps of:
storing, in a memory element for at least one specially programmed computer, an artificial intelligence program (AIP);
implementing a plurality of retail transactions with a business entity using at least one point of sales (POS) device in communication with the at least one specially programmed computer;
determining, using a processor for the at least one specially programmed computer, whether a respective amount due for goods or services included in each retail transaction in the plurality of retail transactions includes a respective first coin amount with a value less than one dollar; and,
for a retail transaction with a first coin amount:
identifying, using the processor, a respective item or service included in each retail transaction included in the plurality of retail transactions;
determining, using the processor, an identification of a respective customer involved in said each retail transaction;
identifying, using the processor, a respective payment method used for said each retail transaction;
evaluating, with respect to a parameter, and using the processor and the AIP, the identification of the respective item or service included in said each retail transaction, the identification of the respective customer for said each retail transaction, and the identification of the respective payment method used for said each retail transaction; and,
determining, using the processor, the AIP, and the evaluation with respect to the first parameter, whether to present a respective offer to provide a respective lottery ticket for a lottery from at least one lottery; and,
for a determination to present the offer:
determining, using the processor, a respective change amount equal to a difference between one dollar and the respective first coin amount;
generating, using the processor and the AIP, the respective offer, the respective offer including the provision of the respective lottery ticket in lieu of providing the respective change amount; and,
transmitting, using an interface device for the at least one specially programmed computer, the respective offer for presentation by the at least one POS device; and,
compiling or updating, using the processor, an offer transaction history including information related to acceptance or refusal of the respective offers, wherein:
evaluating, with respect to a first parameter, includes evaluating the offer transaction history; or
determining whether to present a respective offer to provide a respective lottery ticket includes using the offer transaction history.

11. A self-learning system for providing a lottery ticket at a point of sale device, comprising:
a memory element for at least one specially programmed computer for storing an artificial intelligence program (AIP);
an interface element for the at least one specially programmed computer for communicating with a point of sales (POS) device to implement a retail transaction with a business entity; and,
a processor for the at least one specially programmed computer for determining whether an amount due for goods or services included in the retail transaction includes a first coin amount with a value less than one dollar; and,
for a retail transaction with a first coin amount, the processor is for:
identifying an item or service included in the retail transaction;
determining an identification of a customer for the retail transaction;
identifying a payment method used for the retail transaction;
determining, using the AIP, the identification of the item or service included in the retail transaction, the identification of the customer for the retail transaction, and the identification of the payment method used for said each retail transaction, whether to present an offer to provide a lottery ticket for a lottery from at least one lottery; and,
for a determination to present the respective offer the processor is for:
determining a change amount equal to a difference between one dollar and the first coin amount; and,
generating the offer using the AIP, the offer including the provision of the lottery ticket in lieu of providing the change amount and wherein the interface element is for transmitting the offer for presentation by the POS device.

12. The system of claim 11 wherein the at least one lottery includes a plurality of lotteries and wherein for a determination to present the respective offer, the processor is for:
selecting, using the AIP, a first lottery from the plurality of lotteries; and,
generating the offer to include the provision of a lottery ticket for the first lottery.

13. The system of claim 11 wherein the interface element is for communicating with at least one point of sales (POS) device to implement a plurality of said retail transactions with the business entity, wherein the processor is for determining whether a respective amount due for respective goods or services included in each retail transaction included in the plurality of retail transactions includes a respective first coin amount with a value less than one dollar;
for said each retail transaction with a respective first coin amount, the processor is for:
identifying a respective item or service included in each retail transaction included in the plurality of retail transactions;
determining an identification of a respective customer involved in said each retail transaction;
identifying a respective payment method for said each retail transaction; and,
determining, using the AIP, the identification of the respective item or service included in said each retail transaction, the identification of the respective customer involved in said each retail transaction, and the identification of the respective payment method for said each retail transaction, whether to present a respective offer to provide a respective lottery ticket for a lottery from the at least one lottery; and,
for a determination to present the respective offer the processor is for:
determining a respective change amount equal to a difference between one dollar and the respective first coin amount; and
generating, the respective offer using the AIP, the respective offer including the provision of the respective lottery ticket in lieu of providing the respective change amount, wherein the interface element is for transmitting the respective offer for presentation by the at least one POS device, wherein the processor is for compiling or updating an offer transaction history including information related to acceptance or refusal of the respective offers, and wherein determining whether to present an offer to provide a lottery ticket includes using the offer transaction history.

14. The system of claim 13 wherein the at least one lottery includes a plurality of lotteries and wherein for a determination to present the respective offer, the processor is for:
selecting, using the AIP, a respective lottery from the plurality of lotteries;
generating the respective offer to include the provision of a lottery ticket for the respective lottery;
compiling or updating an offer transaction history including information related to acceptance or refusal of the respective offers; and,
selecting, using the AIP and the offer transaction history, the respective lottery.

15. The system of claim 11 wherein the processor is for evaluating, with respect to a parameter and using the AIP, the item or service included in the retail transaction, the identification of the customer involved in the retail transaction, or the identification of the payment method for the retail transaction and wherein determining whether to present the offer includes using the evaluation with respect to the parameter.

16. The system of claim 11 wherein the processor is for:
accessing a payment method transaction history regarding at least one transaction previously enacted with the business entity using the payment method; and,
using the payment transaction history to determine whether to present an offer to provide a lottery ticket.

17. The system of claim 11 wherein the processor is for:
accessing a customer transaction history regarding transactions previously enacted between the customer and the business entity; and,
using the customer transaction history to determine whether to present an offer to provide a lottery ticket.

18. The system of claim 9 wherein the processor is for:
accessing a retail transaction history regarding at least one transaction previously enacted with the business entity and including the item or service; and,
using the retail transaction history to determine whether to present an offer to provide a lottery ticket.

19. The system of claim 11 wherein when the payment method is other than a credit card, the processor determines not to provide an offer.

20. A self-learning system for providing a lottery ticket at a point of sale device, comprising:
a memory element for at least one specially programmed computer for storing an artificial intelligence program (AIP);
an interface element for the at least one specially programmed computer for communicating with at least one point of sales (POS) device to implement a plurality of retail transactions with a business entity; and,
a processor for the at least one specially programmed computer for determining whether a respective amount due for respective goods or services included in each retail transaction included in the plurality of retail transactions includes a respective first coin amount with a value less than one dollar;
for said each retail transaction with a respective first coin amount, the processor is for:
identifying a respective item or service included in each retail transaction included in the plurality of retail transactions;
determining an identification of a respective customer involved in said each retail transaction;
identifying a respective payment method for said each retail transaction;
evaluating, with respect to a parameter, and using the AIP, the identification of the respective item or service included in said each retail transaction, the identification of the respective customer involved in said each retail transaction, and the identification of the respective payment method for said each retail transaction;
determining, using the AIP, and the evaluation with respect to the parameter, whether to present a respective offer to provide a respective lottery ticket for a lottery from at least one lottery; and,
for a determination to present the respective offer, the processor is for:
determining a respective change amount equal to a difference between one dollar and the respective first coin amount; and,
generating, using the AIP, the respective offer, the respective offer including the provision of the respective lottery ticket in lieu of providing the respective change amount, wherein the interface device is for transmitting the respective offer for presentation by the at least one POS device, wherein the processor is for compiling or updating an offer transaction history including information related to acceptance or refusal of the respective offers and wherein:
evaluating, with respect to a first parameter, includes evaluating the offer transaction history; or,
determining whether to present a respective offer to provide a respective lottery ticket includes using the offer transaction history.
